(19) United States
(12) Patent Application Publication
(10) Pub. No.: US 2010/0276482 A1
(43) Pub. Date: Nov. 4, 2010

(54) APPARATUS AND METHOD FOR MANAGING ENERGY CONSUMPTION WITHIN AN UNOCCUPIED ROOM

(75) Inventors: Thierry Raihi, Miami, FL (US); Aaron Dickey, Miami, FL (US); Lawrence Egle, Miami, FL (US); Yves Tremblay, Miami, FL (US)

Correspondence Address: CARLTON FIELDS, P.A.;Attn: IP Dept., P.O. BOX 3239, TAMPA, FL, 33601-3239, US

(73) Assignee: Smart Light Tech. LLC, Miami, FL (US)

(21) Appl. No.: 12/837,237

(22) Filed: Jul. 15, 2010

Related U.S. Application Data
(63) Continuation-in-part of application No. 11/863,546, filed on Sep. 28, 2007, now Pat. No. 7,784,677.
(60) Provisional application No. 61/225,584, filed on Jul. 15, 2009.
(60) Provisional application No. 60/847,732, filed on Sep. 28, 2006.

(51) Int. Cl. G06F 17/00

(52) U.S. Cl. 235/375

(57) ABSTRACT

A system for reducing energy consumption in an unoccupied room is disclosed in which a battery-powered card reader placed inside a room has a keycard switch adapted to be activated upon insertion of a keycard and to be deactivated substantially upon its removal. The card reader also has a controller and a transceiver and is adapted to transmit an insertion signal substantially upon activation of the keycard switch, a removal signal after the deactivation of the keycard switch, and a periodic status signal indicating the activation state of the keycard switch. At least one secondary unit comprising a means to connect to a power source, a means to connect to a room appliance, a transceiver, and a controller, is adapted to cause a room appliance to enter a powered mode substantially upon receipt of the insertion signal or receipt of a periodic status signal indicating the keycard switch is activated, and to cause that room appliance to enter an energy-saving mode after receiving the removal signal. A gateway connected to a system controller is also provided. The gateway comprises a transceiver adapted to communicate wirelessly with the secondary units, and the system controller is adapted to determine the mode of the secondary units and to cause one or more of said secondary units to change mode if necessary.

### CROSS-REFERENCE TO RELATED APPLICATIONS

This application claims priority from U.S. provisional patent application Ser. No. 61/225,584 filed Jul. 15, 2009 and is a continuation-in-part of U.S. patent application Ser. No. 11/863,546 filed Sep. 28, 2007, which claimed priority from U.S. provisional patent application Ser. No. 60/847,732 filed on Sep. 28, 2006, all herein incorporated by reference in their entirety.

### BACKGROUND

The present invention relates to a system for energy conservation in residential and commercial facilities, with particular application to hotel rooms.

In residential and commercial facilities, and especially hotel and motel rooms, conservation of electrical energy is an important element of controlling operational costs. Occupants of such facilities, however, may not remember to turn off lights and other room appliances when leaving, thereby wasting energy and increasing costs. Where such facilities include adjustable room appliances, such as thermostatically controlled HVAC units, while it is desirable to adjust the heating and air conditioning controls to maintain a comfortable temperature when an occupant is present in the room, it is also desirable to reduce energy consumption by adjusting such heating and air conditioning units to use less energy whenever the room is vacant. Accordingly, it is desirable to have an energy management system (“EMS”) to control consumption of electrical energy in the room, including the consumption by the heating and air conditioning system, to reduce wasteful usage.

In some prior art systems adapted for use in hotel rooms with modern wiring, the EMS may be integrated into the hotel security computer system that controls the use of keycards in the room door lock, so that actuation of the lock by the keycard can cause an adjustment in the room's thermostatic control. However, for existing facilities, extensive and costly rewiring would be required to fully enable such a system. Accordingly, it is an object of the present invention to provide an EMS for residential and commercial facilities that can easily be retrofitted to existing rooms without significant rewiring.

### SUMMARY

According to the present invention, there is provided an energy management system for residential and commercial facilities comprising a card reader unit that is actuated by the insertion of a keycard and that provides for transmission of a first signal to indicate the insertion of such a key and a second signal to indicate removal of such a key. Further, there is provided a secondary unit for controlling the thermostatic control within the room. The secondary unit adjusts the thermostatic control to heat or cool the room to a comfortable temperature upon receipt of a first signal and readjusts the thermostatic control to a more energy efficient setting upon the receipt of a second signal. The signals may conveniently be generated by a transmitter within the card reader or may conveniently be generated by a primary controller that receives signals from a transmitter within the card reader and then wireles sly relays the mode of the card reader to the secondary thermostatic control unit. The signals may also be used to control secondary wall socket units that power appliances and secondary bulb socket units in lighting fixtures.

### BRIEF DESCRIPTION OF THE DRAWINGS

Preferred embodiments of the present invention will now be described by way of example, with reference to the accompanying drawings in which:

FIG. 1 is a plan view of a room in which a preferred embodiment of the energy management system of the present invention has been installed;

FIG. 2 is a block diagram illustrating the components of a preferred embodiment of the energy management system of the present invention installed in a hotel setting;

FIG. 3 is a block diagram illustrating the components of an alternate preferred embodiment of the energy management system of the present invention installed in a hotel setting;

FIG. 4 is a block diagram illustrating the components of another alternate preferred embodiment of the energy management system of the present invention installed in a hotel setting;

FIG. 5 is an exploded, perspective block diagram of a card reader adapted to operate with a preferred embodiment of the energy management system of the present invention;

FIG. 6 is an exploded, perspective block diagram of a secondary unit of a preferred embodiment of the present invention adapted to connect to a wall socket;

FIG. 7 is an exploded, perspective block diagram of a secondary unit of a preferred embodiment of the present invention adapted to connect to a light fixture;

FIG. 8 is a phantom block diagram of a secondary unit of a preferred embodiment of the present invention adapted to serve as a thermostat;

FIG. 9 is a flowchart illustrating the transitions between modes of a preferred embodiment of the energy management system of the present invention; and

FIG. 10 is a flowchart illustrating the transitions between modes of an alternate preferred embodiment of the energy management system of the present invention.

### DESCRIPTION OF PREFERRED EMBODIMENTS

In this specification, “adapted” shall mean configured, dimensioned, arranged, and oriented as appropriate. It shall also be understood that, while preferred embodiments are described herein, such embodiments are illustrative only, and the present invention is not limited to those embodiments.

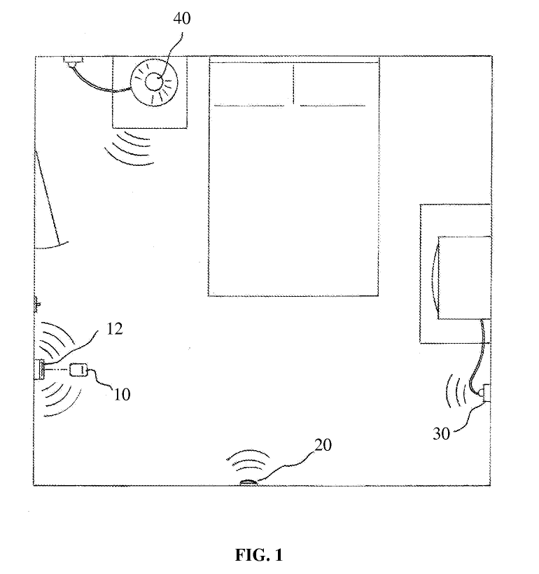

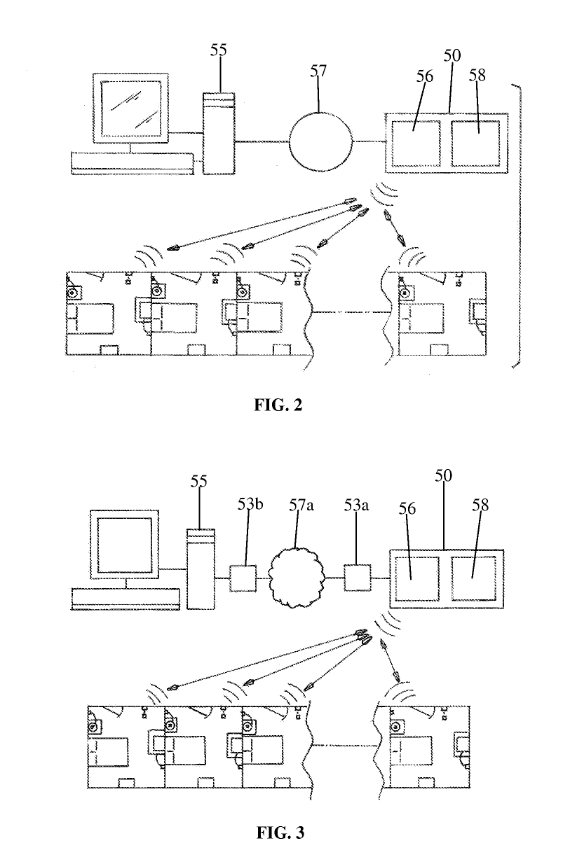

Preferred embodiments of the energy management system (EMS) of the present invention serve to reduce energy consumption in an unoccupied room. As illustrated in FIG. 2, a preferred embodiment of the EMS may be installed in a setting such as a hotel having a plurality of rooms. As shown in FIG. 1, a typical room in such a setting would comprise a battery-powered card reader 12 dimensioned and configured to receive keycard 10. Preferably, card reader 12 will be installed proximate to the door so that it can be easily located upon entry into the room.

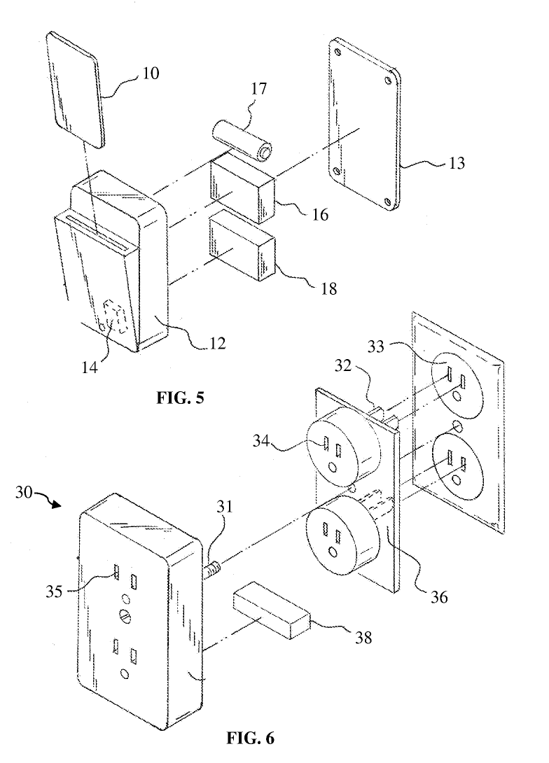

Keycard 10 is preferably a standard keycard used to unlock a room such as a hotel room and as is well known in the art. Allowing keycard 10 to be a standard keycard further simplifies installation into existing buildings. As is illustrated in FIG. 5, card reader 12 comprises keycard switch 14 positioned, dimensioned and configured to be activated substantially upon insertion of keycard 10 into card reader 12 and to be deactivated substantially upon removal of keycard 10 from card reader 12. Keycard switch 14 is preferably a mechanical micro-switch as is well known in the industry. Alternatively, keycard switch 14 may also be an optical switch (activated and deactivated by the interruption of a beam of light), a magnetic switch (activated and deactivated by the presence or disturbance of a magnetic field, or any other type of switch, many of which are well known to those of ordinary skill in the art. For additional security, keycard switch 14 may also be adapted to comprise a magnetic strip or similar reader capable of reading the magnetic strip or similar security device on a keycard to ensure that the keycard is the correct keycard for the room. Such embodiments, while more expensive, have the added advantage of requiring a keycard 10 specifically associated with a particular room in order to activate the card reader 12 in that room.

Card reader 12 is battery-powered and, hence, adapted to receive battery 17 which may be any of a wide range of batteries known in the art, but will preferably be either one or more standard AA or AAA batteries, or a longer lasting or rechargeable battery such as those commonly used in cameras. It is preferred to use a longer-lasting battery in order to reduce the frequency with which battery 17 needs to be replaced or recharged. In the event a power source such as an outlet, thermostat wiring, or other power wiring is near card reader 12, card reader 12 may further comprise a recharging circuit (not shown) adapted to keep battery 17 charged. However, no such power source is required. In fact, being battery-powered, card reader 12 may be installed in any convenient location in the room, without regard to the locations of outlets or power lines. This alleviates the need the run additional power wires during system installation, which is desirable where an EMS is to be installed into an existing building.

Card reader 12 further comprises a card reader controller 16 electrically connected to keycard switch 14, and a card reader transceiver 18 electrically connected to card reader controller 16. While card reader controller 16 and card reader transceiver 18 are illustrated in block diagram form on FIG. 5, it is understood that card reader controller 16 and card reader transceiver 18 are electronic components preferably comprising one or more circuit boards installed in card reader 12 and powered by battery 17. Card reader 12 may be attached to a wall or piece of furniture through a backing plate 13.

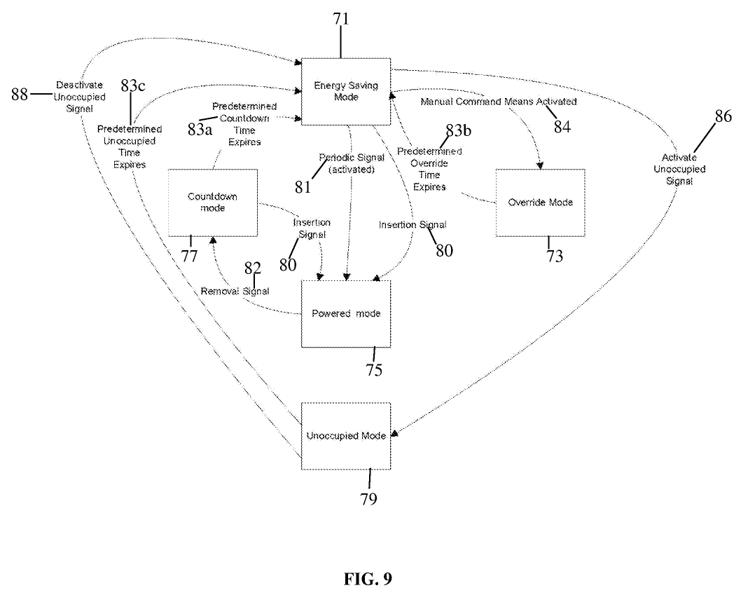

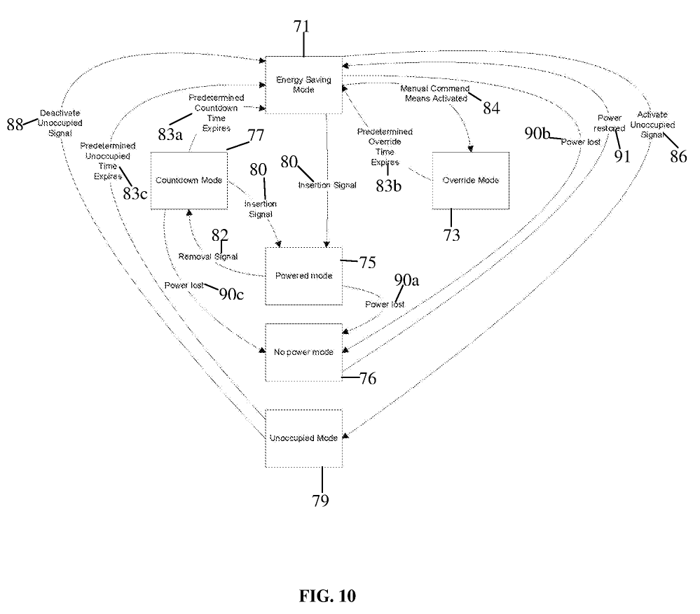

Card reader controller 16 preferably comprises a microprocessor or microcontroller (not shown) having a preferably non-volatile memory (not shown) adapted to house software capable of directing the operation of card reader controller 16 and card reader transceiver 18. Through such software, card reader controller 16 is adapted to cause card reader transceiver 18 to transmit a wireless insertion signal 80 (FIGS. 9 and 10) substantially upon activation of keycard switch 14, a removal signal 82 (FIGS. 9 and 10) after the deactivation of keycard switch 14, and a periodic status signal 81 (FIG. 9) which periodically indicates the activation status of keycard switch 14. Insertion signal 80, removal signal 82, and periodic status signal 81 are described further below. It will be understood by those of ordinary skill in the art that, while a programmable microprocessor, memory, and updatable software are preferred for card reader controller 16 and card reader transceiver 18, the operation of the present invention may also be implemented in hardware-only configurations.

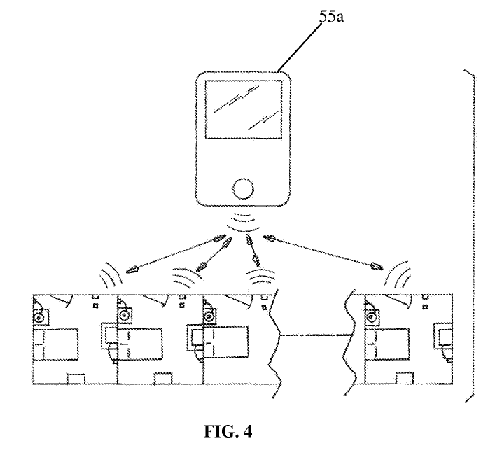

Card reader transceiver 18 is a wireless transceiver capable of sending and receiving wireless signals. While card reader transceiver 18 is preferably a low-powered, short-distance, digital transceiver, it may also be an analog transceiver in certain embodiments. Low-powered, short-distance transceivers are preferred in order to increase the intervals in between changes or recharges of battery 17. Digital transceivers are preferred because digital signals can participate in networks that allow them to carry additional information without interference between adjacent rooms and can thereby conveniently communicate with system controller 55 (illustrated on FIGS. 2 and 3) through a gateway 50 (illustrated on FIGS. 2 and 3), or directly with system controller 55a (illustrated on FIG. 4) through such networks. System controllers 55 and 55a are general purpose computers (55) or portable and preferably handheld devices (55a) such as a personal data assistant or cell phone adapted to communicate on wireless digital networks. System controllers 55 and 55a are described more fully below.

Card reader transceiver 18 is preferably adapted to allow card reader controller 16 to communicate wirelessly on a digital mesh network such as a network conforming to IEEE standard 802.15.4., incorporated herein by reference, or the ZigBee standard which is described at www.ZigBee.org. Networks such as IEEE 802.15.4 and ZigBee networks allow relatively inexpensive embedded devices to communicate digitally with minimal interference and cross-talk problems. Such networks are also mesh networks, which increase potential communication range by allowing individual devices to act as repeaters that carry messages to and from remote devices so that there is no need for each device to communicate directly with every other device on the network. Networks such as IEEE 802.15.4 and ZigBee networks may be encrypted or unencrypted depending on the security needs of the particular installation. Such networks also commonly incorporate a network identifier that is hard-wired or programmed into each device that participates in the network. This allows a particular hardware provider to enable its devices to communicate together while ignoring the communications from devices of other providers, as well as ignoring communications from other nearby networks which may be serving other purposes. Topics relating to encryption, security, and avoidance of interference with adjacent networks are discussed more fully in the incorporated references. A number of manufacturers including without limitation FreeScale Semiconductor make transceiver components capable of participating in such networks and adaptable for use in preferred embodiments of the present invention.

Referring to FIGS. 1, 5 and 9, and as is apparent from the foregoing description, upon entering a room having a preferred embodiment of the EMS of the present invention installed, the occupant inserts keycard 10 into card reader 12, thus activating keycard switch 14. Substantially upon such insertion, card reader controller 16 causes keycard transceiver 18 to transmit insertion signal 80. Upon leaving the room, the occupant removes keycard 10, thereby deactivating keycard switch 14. Either immediately, or after a predetermined delay time which allows the occupant to exit the room, card reader controller 16 causes keycard transceiver 18 to transmit removal signal 82. As will be discussed more fully below, keycard controller 16 will also cause keycard transceiver 18 to periodically send out a periodic signal 81 indicating the activation status of keycard switch 14. This allows devices that may have lost track of the insertion status of keycard 10 to be reminded of the insertion status, without requiring keycard transceiver 18 to be powered and ready to status requests at all times. Not requiring keycard transceiver 18 to be powered on at all times helps increase the life of battery 17.

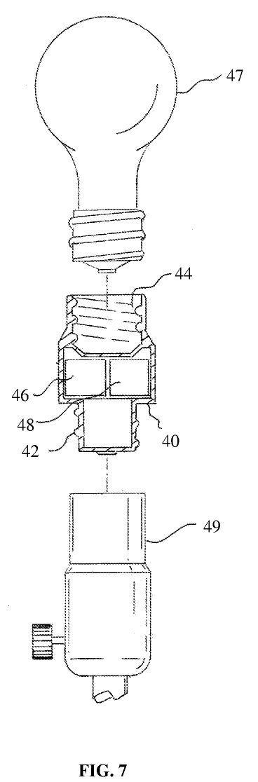

Signals transmitted by card reader 12 are received by at least one secondary unit 20, 30, 40. Secondary units 20, 30, 40 comprise a means to connect to a power source and a means to connect to a room appliance and a secondary unit transceiver 28, 38, 48, shown on FIGS. 6, 7 and 8. Secondary units 20, 30, 40 further comprise a secondary unit controller 26, 36, 46 electrically connected to the means to connect to a power source, the secondary unit transceiver 28, 38, 48, and the means to connect to the room appliance. The secondary unit controller 26, 36, 46, like card reader controller 16, preferably comprises a microprocessor or microcontroller having a preferably non-volatile memory adapted to house software capable of directing the operation of the secondary unit controller 26, 36, 46 and the secondary unit transceiver 28, 38, 48. In this way, the secondary unit controller 26, 36, 46 is adapted to cause a room appliance to enter a powered mode 75 substantially upon the secondary unit transceiver 28, 38, 48 receiving the insertion signal 80 that indicates keycard 10 has been inserted into card reader 12, and to cause that appliance to enter an energy-saving mode 71 subsequent to the secondary unit transceiver 28, 38, 48 receiving the removal signal 82 that indicates that keycard 10 has been removed from card reader 12. In this way, when an occupant enters a room and inserts keycard 10 in to card reader 12, the room appliances such as lights, electrical outlets, on-demand water heaters, certain heating and air conditioning units, etc. are activated by the secondary unit 20, 30, 40 connecting the power source to the appliance, thereby causing the room appliances to enter a powered mode 75. When the occupant leaves the room, he or she will remove keycard 10 from card reader 12, the room appliances are deactivated by the secondary unit disconnecting the power source from the room appliance and thereby causing the room appliance to enter an energy saving mode 71. The entry into the energy saving mode 71 may, but is not required to, occur after a delay. That delay allows the occupant time to leave the room before the appliances are deactivated.

While for many room appliances, such as lights and electrical outlets powering appliances, such as televisions, are not required to operate at all when in an energy saving mode 71, other room appliances may be required to operate but at a lower power setting. Secondary units 20, 30, 40 for such room appliances will not simply turn the appliance off, but will adjust the appliance to enter a fully powered or occupant-adjustable mode substantially upon the secondary unit receiving insertion signal 80 and will adjust the appliance to enter a more efficient or energy-saving mode 71 upon the secondary unit 20, 30, 40 receiving removal signal 82. One example of such a room appliance is a thermostatically controlled heating and air conditioning unit. In its fully powered mode the secondary unit would initially adjust the room temperature to a comfortable temperature for an occupied room, and in its energy-saving mode it would adjust the temperature down (in the event the unit is set to heat the room) or up (in the event the unit is set to cool the room) by a pre-determined amount, thereby reducing the energy consumption of the unit when the room is unoccupied. Were the unit simply turned off when the room is unoccupied, the room temperature could reach a level at which return of the room to a comfortable occupied temperature would require an excessive amount of time. Accordingly, where such a time lag is undesirable, secondary units 20, 30, 40, such as those incorporated into thermostats, are preferred. A second example of such a secondary unit might be a water heater.

The secondary unit controllers 26, 36, 46 are also preferably adapted to cause the room appliance to enter a powered mode 75 substantially upon the secondary unit transceiver 28, 38, 48 receiving a periodic status signal 81 indicating keycard switch 14 is activated. In this way, secondary units 20, 30, 40 can more readily adapt to power outages. Secondary units 20, 30, 40 will preferably receive power from an external power source such as an electrical outlet, a light fixture, or thermostat wiring. In the event power is lost, card reader 12 will still be able to send insertion signal 80 and removal signal 82 because card reader 12 is powered by battery 17. However, if secondary unit 20, 30, 40 are not powered, they will not be able to react to the signals. When power is returned, secondary units 20, 30, 40 may have lost track of whether keycard 10 is inserted or removed as a mode-change may have occurred while the power was out.

This problem could be solved by adapting the secondary unit controllers 26, 36, 46 to cause the room appliance to enter an energy-saving mode 71 and then send a power restored signal 91 (shown on FIG. 10) upon the power source again becoming live. Upon receiving the power restored signal 91, card reader controller 16 could cause card reader transceiver 18 to re-transmit insertion signal 80 if keycard 10 is inserted. Such embodiments are well adapted to installations in which card reader 12 has a power source other than battery 17 as they require card reader transceiver 18 and card reader controller 16 to be powered at all times so that they are ready to receive power-restored signal 91 (shown on FIG. 10) if it is sent. Embodiments of card reader 12 that depend solely on battery 17 for power, however, are less well-suited to such a solution as having card reader controller 16 and card reader transceiver 18 powered at all times would run down battery 17 more quickly. In such embodiments, a preferred solution is to adapt card reader controller 16 to cause card reader transceiver 18 to send a periodic status signal 81 indicating whether keycard switch 14 is activated or deactivated. In this way, upon receiving power again, secondary units 20, 30, 40 need only wait until the next periodic status signal 81 to determine the current keycard mode. In the event secondary units 20, 30, 40 have non-volatile memories, the secondary unit controllers 26, 36, 46 may default to the last saved mode upon power being returned. Alternatively, the secondary unit controllers 26, 36, 46 may default to an energy-saving mode 71 until such time as an insertion signal 80 or a periodic status signal 81 indicating the keycard switch 14 is activated is received. Other embodiments may take the reverse approach, making the powered mode 75 the default until such time as removal signal 82 or a periodic status signal 81 indicating the keycard switch 14 is deactivated is received. This approach is preferred as it offers greater safety, allowing room appliances to be used immediately upon restoration of power. In either event, the time during which the secondary unit 20, 30, 40 is not synchronized with card reader 12 is limited to no longer than the time between periodic status signals 81. At the same time, the life of battery 17 is extended as it need only power card reader transceiver 18 upon insertion and removal of keycard 10 and for brief instants required to send the periodic status signals.

Embodiments of secondary units and transitions between various room modes are discussed more fully below.

As has been described above, card reader 12 and secondary units 20, 30, 40 may all communicate wirelessly. It may also be desirable to allow a user to monitor the status of secondary units 20, 30, 40 and/or card reader 12 in a plurality of rooms in which the EMS is installed. Referring now to FIG. 2, this may be accomplished with a gateway 50 and a system controller 55 connected to gateway 50. Although this connection is preferably via a wired or wireless local area network 57, it may also be a direct connection such as a USB (not shown) or a Bluetooth (not shown) connection or any number of other connection types (not shown) known to those of ordinary skill in the art. Gateway 50 preferably comprises a gateway transceiver 58 adapted to communicate wirelessly with card reader transceiver 18 and secondary unit transceivers 28, 38, 48. Gateway transceiver 58, therefore, may preferably be the same type of wireless transceiver as is used in card reader 12 and secondary units 20, 30, 40. In the event a mesh network such as an IEEE 802.15.4. or ZigBee network is used, gateway transceiver 58 may be a low-powered, digital transceiver. The reason a short-range transceiver may be used is that such networks allow each transceiver to pass on signals received from other transceivers in range as is described more fully in the incorporated references. In this way, a signal to or from a transceiver that is out of range of gateway transceiver 58 may be sent or received by having that signal relayed by intermediate transceivers. Of course, other types of wireless network technologies may also be used, although power requirements may be impacted.

Gateway 50 further comprises a gateway controller 56 connected to gateway transceiver 58. As with card reader controller 16 and the secondary unit controllers 26, 36, 46, gateway controller 56 preferably comprises a microprocessor or microcontroller and a preferably non-volatile memory adapted to store software capable of directing the operation of gateway transceiver 58. In addition, however, gateway controller 56 is adapted to send and receive signals to system controller 55. In the event gateway 50 and system controller 55 are connected via a local area network 57, gateway controller 56 would further comprise a network interface such as wired or wireless Ethernet adapter. In the event the connection is via USB, gateway controller 56 would further incorporate a USB controller. Software stored in the gateway controller 56 would then allow translation and relay of signals to and from card readers and secondary units from and to system controller 55, thereby enabling system controller 55 to be adapted to determine the mode of the card readers 12 and secondary units 20, 30, 40 and/or to change such modes.

System controller 55 is preferably a general purpose computer or personal data assistant. For example, and without limitation, in a hotel setting, a general purpose computer at the front desk could be adapted to serve as system controller 55 by connecting it to gateway 50 either directly or via a local area network 57, and then installing software configured to send and receive data to and from gateway controller 56. Such software could then allow a hotel employee to monitor the status of each room having the EMS of the present invention installed and could allow that employee to change the mode of individual rooms if needed. Such software could also allow the user to change settings for one or more rooms such as the delay periods between removal of keycard 10 and the change from a fully-powered mode 75 to an energy saving mode 71, or the temperature setting in an energy-saving mode 71. Such an employee could also direct a room to go into an unoccupied mode for additional energy savings periods during which the room will be unoccupied for an extended time, such as during an off season or for renovations. Additional modes that may be triggered from system controller 55 are discussed further below.

As is noted above, gateway 50 and system controller 55 may be connected in a variety of ways. As is illustrated in FIG. 3, in an alternate embodiment of the EMS of the present invention, gateway 50 and system controller 55 are connected through a wide area network 57a such as the Internet. As is well understood by those of ordinary skill in the art, in such configurations, gateway 50 may be connected to a router 53a which provides connectivity to wide area network 57a. System controller 55 is similarly connected to a router 53b that offers connectivity to the same wide area network 57a, thereby enabling it to communicate with gateway 50. Such communications may be encrypted utilizing passwords, certificates and protocols such as HTTPS, which are well known to those of skill in the art, to provide security and make it difficult for third parties to communicate with gateway 50 or system controller 55 without authorization. In such embodiments, system controller 55 may be in a remote location such as a corporate office or a remote service center, thereby allowing an operator in a remote location to monitor and adjust EMS enabled rooms in a multiple locations from a single system controller 55.

A further embodiment of system controller 55a is illustrated in FIG. 4. In such embodiments, system controller 55a is a portable device such as a personal data assistant (PDA), a programmable wireless phone (Smart Phone), a laptop or portable computer, or a custom handheld or portable computer. System controller 55a comprises a wireless transceiver (not illustrated) adapted to communicate directly with the secondary unit transceivers 28, 38, 48, thereby eliminating the need for gateway 50. System controller 55a will further comprise software providing the functionality described above but on an interface adapted for the portable device. In this way, a person using the portable device could monitor and adjust the EMS system of the present invention while walking anywhere within range of a secondary unit 20, 30, 40.

It will be understood by those of ordinary skill in the art that the embodiments illustrated in FIGS. 2, 3, and 4 are not mutually exclusive. There is no reason why multiple system controllers of different types may not be used to monitor and adjust the secondary units 20, 30, 40 in the same set of rooms. In this way, a system controller 55 at the front desk of a hotel connected to gateway 50 via network 57 could be augmented by one or more portable system controllers 55a adapted to communicate directly with secondary devices 20, 30, 40 and card readers 12, and supported by a second system controller 55 in a remote support center connected to gateway 50 though wide area network 57a. In such embodiments, system controllers 55 and 55a would preferably either read the current settings from secondary units 20, 30, 40, or would be adapted to synchronize changes so that updates made on one system controller 55, 55a would be reflected on other system controllers 55, 55a. Methods of storing system settings in memories in secondary unit controllers 26, 36, 46 and card reader controller 16, or synchronizing such settings between system controllers 55, 55a are known to those of skill in the art and need not be explained further herein. <CONSIDER FILING SECOND PROVISIONAL WITH SOFTWARE DOCUMENTATION>

Examples of certain embodiments of secondary units 20, 30, 40 will now be described in further detail. It will be understood by those of ordinary skill in the art that the embodiments described herein are examples and that the present invention is not limited to EMS embodiments utilizing such examples.

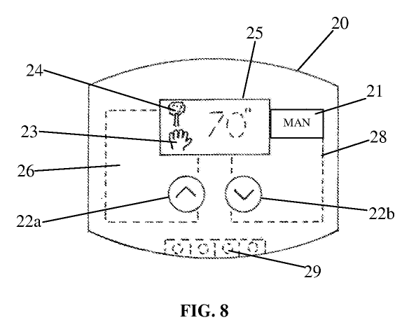

Referring to FIG. 8, one such secondary unit embodiment is secondary unit/thermostat 20. In such embodiments, secondary unit/thermostat 20 is in the form of a thermostat adapted to connect to and control a room appliance in the form of a heating and air conditioning unit. Secondary unit/thermostat 20 may conveniently comprise a display 25 indicating the current temperature setting. When in powered mode 75 (shown on FIGS. 9 and 10), a room occupant may adjust that setting via control buttons 22a and 22b. Preferably, a manual mode icon 23 will be displayed providing a visual indication to the room occupant that the secondary unit is in powered mode 75 and aiding in troubleshooting. When in energy saving mode 71 (shown on FIGS. 9 and 10), an energy saving icon 24 may be displayed likewise. As is understood by those of skill in the art there are many variations of thermostatic controls for adjusting temperature settings and many methods of communicating a particular operational mode to a user. The present invention is limited only by the claims and should not be construed to be limited to any one type of thermostatic control or one type of indicator.

Standard thermostat wiring may be used to connect secondary unit/thermostat 20 to a heating and air conditioning unit such as an HVAC unit or even a wall or window mounted heater and air conditioner. The means to connect to a room appliance may be a terminal block 29, similar or identical to terminal blocks typically used on thermostats and well known in the art. The means to connect to a power source may be the same terminal block 29 as many electronic thermostats receive power directly from such wiring. Other possible means for connecting to a power source may include a battery (not shown) in secondary unit/thermostat 20 or a connection to 110 volt power source and a converter (not shown) to step the power down to the level required by the components of secondary unit/thermostat 20.

Substantially upon secondary unit transceiver 28 receiving insertion signal 80 or periodic signal 81 indicating keycard switch 14 is activated (or upon recovering from a power loss if powered mode 75 is the chosen default mode), secondary unit controller 26 will enter powered mode 75 and adjust the desired temperature setting within the room up a set number of degrees (preferably 5), if the HVAC unit is set to heating mode, or down a set number of degrees (preferably 5), if the HVAC unit is set to cooling mode. Secondary unit/thermostat 20 will then, through its ordinary functioning, direct the HVAC unit to begin heating or cooling the room as appropriate for an occupied room and allow the room occupant to make any desired temperature adjustments. Upon receiving removal signal 82 or periodic signal 81, indicating keycard switch 14 is deactivated (or upon recovering from a power loss if energy-saving mode 71 is the chosen default mode), from secondary unit/thermostat 20 will enter energy saving mode 71 and, through its ordinary functioning, direct the HVAC unit to begin heating or cooling the room as appropriate for an unoccupied room.

Referring to FIG. 7, a further embodiment of a secondary unit is a light controller adapted to operate with a standard lighting fixture such as a lamp. Preferably, secondary unit/lighting controller 40 will comprise a male light socket portion 42, which is configured to engage a light bulb socket 49, such as is commonly found in a table lamp, floor lamp, fixed overhead light, track light, desk light or other lighting fixture. In this way, secondary unit/lighting controller 40 may conveniently be used with existing lighting fixtures, thereby simplifying installation and reducing implementation costs. Secondary unit/light controller 40 further comprises female light socket portion 44 configured to engage a light bulb 47. Light socket portion 44 may be adapted to receive any type of lighting device such as an incandescent bulb or a fluorescent bulb or tube. Secondary unit controller 46, as with secondary unit controller 26 and card reader controller 16, secondary unit controller 46 is an electronic circuit preferably comprising a microcontroller or microprocessor and a preferably non-volatile memory capable of storing software capable of directing the operation the microcontroller or microprocessor. Secondary unit controller 46 is electrically connected to male light socket portion 42 and female light socket portion 44. Secondary unit controller 46 is also electrically connected to secondary unit transceiver 48, which, like secondary unit transceiver 28 and card reader transceiver 18 is a wireless transceiver preferably adapted to communicate on a digital wireless mesh network conforming to a standard such as IEEE 802.15.4.or ZigBee. Secondary unit controller 46 is configured to cause secondary unit/light controller 40 to connect male light socket portion 42 to female light socket portion 44 substantially upon secondary unit transceiver 48 receiving insertion signal 80, or periodic signal 81, indicating that keycard 10 is present in card reader 12. It is further configured to disconnect female light socket portion 44 from male light socket portion 42 subsequent to secondary unit transceiver 48 receiving removal signal 82. In this way, secondary unit/light controller 40 can cause a room appliance, typically a light fixture, to enter powered mode 75 substantially upon keycard 10 being inserted into card reader 12 by connecting power to the secondary unit/lighting controller 40, and to enter an energy saving mode 71 subsequent to keycard 10 being removed by disconnecting the power and turning off the light. For safety and convenience purposes it is preferable for the EMS system to delay the turning of the lights for a predetermined time after keycard 10 has been removed either by adapting card reader controller 16 to delay the transmission of removal signal 82 or by adapting secondary unit controller 46 to delay disconnecting power once the signal have been received.

It is convenient to allow secondary unit controller 46 and secondary unit transceiver 48 to be powered by light bulb socket 49, thereby eliminating the need for a battery or other power source for secondary unit/lighting controller 40. In such embodiments, however, a loss of power may disable secondary unit transceiver 48. In that event, it is possible that secondary unit 40 will lose track of whether keycard 10 is inserted or removed. There are at least two methods of addressing such situations. One method would be for secondary unit controller 46 to be adapted to cause secondary unit transceiver 48 to transmit a power restored signal 91 (shown on FIG. 10) each time power is activated. Card reader transceiver, upon receiving power restored signal 91 could then transmit insertion signal 80 if keycard 10 is inserted. Otherwise, secondary unit/lighting controller 40 could default to energy saving mode 71. Such embodiments, however, are better suited to installations in which card reader 12 has a power source other than battery 17 as such embodiments require card reader 18 to be actively listening, thereby decreasing battery life. An alternative solution is to configure secondary unit controller 46 to default to powered mode 75 for a predetermined time upon power being activated or restored. If that predetermined time is at least as long as the time between transmissions of periodic signal 81, then secondary unit/lighting controller 40 could remain in powered mode 75 for a short time only. If, during that time, periodic signal 81 indicating that keycard 10 is inserted is received, secondary unit controller 46 could remain in powered mode 75 until removal signal 82 is received. If no periodic signal 81 is received during that time, or periodic signal 81 indicating that no keycard 10 is received, secondary unit controller 46 could return to energy saving mode 71.

Referring to FIG. 6, a further embodiment a secondary unit 30 is an outlet controller adapted to work with standard, plug-in-type room appliances such as lamps, radios, televisions, game consoles, hair dryers, irons, and the like. Preferable secondary unit/outlet controller 30 will comprise a female wall socket portion 34 configured to receive a standard male electrical plug such as is normally attached to a wired appliance, and which may, but need not, conveniently be covered by a cover 35 with appropriate openings. Outlet controller 30 further comprises secondary unit controller 36. As with secondary unit controllers 26 and 46, secondary unit controller 36 is an electronic circuit preferably comprising a microcontroller or microprocessor and a preferably non-volatile memory capable of storing software capable of directing the operation the microcontroller or microprocessor. Secondary unit controller 36 is configured to connect a power source (such as an existing electrical outlet or wires carrying electrical power) to female wall socket portion 34. As is illustrated in FIG. 6, this may be accomplished in one embodiment by providing secondary unit/outlet controller 30 with male prongs 32 adapted to connect to a standard wall outlet 33 which serves as the power source for a room appliance. Secondary unit transceiver 38 is also electrically connected to secondary unit controller 36, which, similar to secondary unit controller 46 in light controller 40 (FIG. 7), is configured to connect the power source (in this case wall outlet 33) to a female wall socket portion 34 substantially upon secondary unit transceiver 38 (which, like secondary unit transceivers 28 and 48 and card reader transceiver 18 is a wireless transceiver preferably adapted to communicate on a digital wireless mesh network conforming to a standard such as IEEE 802.15.4. or ZigBee) receiving insertion signal 80 or periodic status signal 81 indicating that keycard switch 14 (FIG. 5) is activated. In this way, secondary unit/outlet controller 30 may conveniently be used with any plug-in-type room appliance. When insertion signal 81 is received, secondary unit controller 36 connects the power source to female wall socket portion 34, thereby putting any connected room appliance into powered mode 75. Subsequent to receiving removal signal 82, secondary unit controller 36 disconnects the power source 33 from female wall socket portion 34, thereby putting any connected room appliance into energy saving mode 71. As with secondary unit/light controller 40 (FIG. 7) discussed above, a delay between receipt of removal signal 82 and the disconnection of female wall socket portion 34 may be desirable to allow the occupant time to exit the room before appliances are turned off. Also like secondary unit/light controller 40 (FIG. 7), secondary unit/outlet controller 30 may have secondary unit controller 36 and secondary unit transceiver 38 powered by power source 33, thereby eliminating the need for a separate power source such as a battery. In such cases, the need to respond to power losses may be even more important as certain wall outlets may be controlled by switches controllable by the room occupant. In such cases, secondary unit/outlet controller 36 may perceive no difference between a building-wide power loss and the turning off a switch by an occupant. The same methods described above, however, as may be used to allow secondary unit/light controller 40 to respond to power outages, may conveniently be used with secondary unit/outlet controller 30.

As is illustrated in the figure, one means to connect to a power source that may conveniently be used with secondary unit/outlet controller 30 would be male wall socket portion 32 adapted to plug into a standard wall outlet. Other possible means to connect to a power source 33 would include a terminal block, screws, or other mechanical connectors (not shown) adapted to connect directly to electrical wiring. In such embodiments, secondary unit/outlet controller 30 could be wired directly into a room in the same manner as a standard electrical outlet. A variety of such mechanical connectors are well known to those or ordinary skill in the art. Furthermore, secondary unit/outlet controller 30 may further comprise a means to secure secondary unit/outlet controller 30 to an electrical outlet or wall. Such means would make it more difficult to remove secondary unit/outlet controller 30 and plugging appliances directly into an underlying electrical outlet 33. One such means may be as simple as a screw 31 adapted to engage an electrical box or outlet in the same way that a screw holding on an outlet cover plate may be attached. A variety of positionings, screw and bolt configurations, and other mechanical means to secure secondary unit/outlet controller 30 to an outlet or electrical box will be readily apparent to those of skill in the art.

As will be understood by those of ordinary skill in the art, there may be times where it is desirable to allow a room occupant to cause a room appliance to enter powered mode 75 for a short period of time, even if no keycard 10 is in card reader 12. For example, if a service worker needs to be in the room for a short time, if there is a problem with card reader 12, or if the room occupant is confused about the operation of the EMS, then it may be desirable for the occupant to have a method of overriding the EMS for a predetermined period of time. Referring again to FIG. 8, such a manual command means may be in the form of a command switch 21 on secondary unit 20. Similar switches may be installed on any secondary unit/outlet controller 30 (not illustrated) or secondary unit/lighting controller 40 (not illustrated) as well. Substantially upon activation of manual command means, the secondary unit controller 26, 36, 46 will cause the room appliance to enter powered mode 75 for a predetermined period of time, after which secondary unit controller 26, 36, 46 will return the room appliance to energy saving mode 71. In this way, the room appliance can be activated for a limited period of time without a keycard 10. In addition to using a manual command switch 21, an alternate manual command means may comprise system controller 55 causing gateway 50 to transmit an enter-override-mode signal (not illustrated) to one or more secondary units 20, 30, 40 in a given room. In this way, a room occupant could call the operator of system controller 55 (i.e. a front desk worker), who would then enter a command into system controller 55, thereby activating the secondary units 20, 30, 40 in the applicable room for a period of time.

It will be further understood by those of ordinary skill in the art that during extended periods of vacancy, it may be desirable to cause secondary units 20, 30, 40 to enter a power saving mode 71 for an extended time. This may be accomplished by adapting system controller 55 to cause gateway 50 to transmit an enter-occupied-mode signal to one or more secondary units 20, 30, 40 in a given room or set of rooms. Secondary unit controllers 26, 36, 46 may then be adapted to cause their room appliances to enter unoccupied mode 79 (shown of FIGS. 9 and 10) which is a power-saving mode that preferably uses less power than energy saving mode 71. In this way, for example, a secondary unit/thermostat 20 could cause an HVAC unit to maintain enough heat in a room to prevent pipes from freezing during a winter season, or could cause a secondary unit/outlet controller 30 to allow a light to be turned on in a room if it need be entered during the off-season, while all other secondary units 20, 30, 40 remain turned off. Unoccupied mode 79 could be terminated upon expiration of a pre-determined time period communicated to secondary units 20, 30, 40 as part of activate-unoccupied-mode signal 86, or could be terminated at the end of a pre-determined time. In either event, upon termination of unoccupied mode 79, secondary units 20, 30, 40 may conveniently return to normal energy-saving mode 71.

FIGS. 9 and 10 further illustrate the transitions between operational modes of preferred embodiments of the EMS of the present invention. FIG. 9 illustrates typical transitions in an embodiment in which card reader 12 is powered only by battery 17 so that it is preferred that card reader transceiver 18 not be required to be powered on at all times, thereby reducing battery life. In such embodiments, secondary units 20, 30, 40 in a given room begin in energy saving mode 71. Upon insertion of keycard 10, card reader 12 transmits insertion signal 80, thereby causing secondary units 20, 30, 40 to enter powered mode 75. Alternatively, if a given secondary unit 20, 30, 40 is in energy saving mode 71, it will be transitioned to powered mode 75 upon card reader 12 transmitting periodic signal 81 indicating that keycard 10 is present.

Once in powered mode 75, if keycard 10 is removed, card reader 12 may transmit removal signal 82. Substantially upon receiving removal signal 82, one or more secondary units 20, 30, 40 may enter countdown mode 77 for a predetermined period of time. While in countdown mode 77, room appliances would remain powered until the countdown expires, thereby allowing the occupant to exit the room. It will be understood by those of ordinary skill in the art that other embodiments may eliminate countdown mode 77 and, if the countdown feature is desired, configure card reader controller 16 to delay the transmission of removal signal 82. In such embodiments, substantially upon receiving removal signal 82, secondary units 20, 30, 40 would return to energy saving mode 71. In embodiments in which the delay is implemented by secondary units 20, 30, 40, would return to energy saving mode 71 from countdown mode 77 substantially upon expiration of the countdown time 83a.

From energy saving mode 71, a secondary unit 20, 30, 40 may enter override mode 73 substantially upon activation of manual command means 84. As discussed above, while in override mode 73, secondary unit 20, 30, 40 would place their associated room appliance into a powered mode 75 for a predetermined period of time. Upon expiration of the predetermined override time 83b, the room appliance is returned to energy saving mode 71.

A further transition from energy saving mode 71 to unoccupied mode 79 may occur upon secondary units 20, 30, 40 receiving activate-unoccupied-mode signal 86, which may include an expiration time for the mode. As is described above, when in unoccupied mode 79, secondary units 20, 30, 40 would place room appliances into an enhanced energy savings mode 71 convenient for an extended vacancy period. Upon reaching the predetermined unoccupied time expiring 83c, or receipt of a signal to deactivate unoccupied mode 88, secondary units 20, 30, 40 would return the room appliances to energy saving mode 71. The signal to activate unoccupied mode 86 and deactivate unoccupied mode 88 may come from system controller 55 through gateway 50, or directly from system controller 55a.

FIG. 10 illustrates preferred transitions between modes in an alternate embodiment in which card reader transceiver 18 is continually powered. In such embodiments the transitions discussed above are largely identical except that periodic signal 81 (shown on FIG. 9) is unnecessary. Instead, upon receiving power being lost, if secondary units 20, 30, 40 are in powered mode 75, countdown mode 77, or energy saving mode 71, they will transition to no-power mode 76. Upon power being restored 91, secondary units 20, 30, 40 may return to energy saving mode 71 and transmit a status inquiry signal (not illustrated). Upon receipt of the status inquiry signal, if keycard 10 is inserted, card reader 12 will transmit insertion signal 80, thereby causing secondary units 20, 30, 40 to return to powered mode 75.

It will also be understood that the present invention is not limited to the preferred embodiments described herein which are used to illustrate the principles of the EMS of the present invention. It will also be understood that the present invention is not limited to use in a hotel, but may also be used in a condominium or apartment structure, in a home or business, or in any other environment where it is desirable to control power consumption in an unoccupied room. Equivalent elements, components, and materials can be substituted for the elements employed in this invention to obtain substantially the same results in substantially the same way.

What is claimed is:

1. A system for reducing energy consumption in an unoccupied room comprising:
a battery-powered card reader inside said room dimensioned and configured to receive a keycard and comprising a keycard switch positioned, dimensioned and configured to be activated substantially upon insertion of said keycard into said card reader and to be deactivated substantially upon removal of said keycard from said card reader, a card reader controller electrically connected to said keycard switch, and a card reader transceiver electrically connected to said card reader controller, said card reader controller being adapted to cause said card reader transceiver to transmit an insertion signal substantially upon activation of said keycard switch, a removal signal after the deactivation of said keycard switch, and a periodic status signal indicating the activation state of said keycard switch;
at least one secondary unit comprising a means to connect to a power source, a means to connect to a room appliance, a secondary unit transceiver, and a secondary unit controller electrically connected to said means to connect to a power source, said secondary unit transceiver, and said means to connect to a room appliance, said secondary unit controller being adapted to cause said room appliance to enter a powered mode substantially upon said secondary unit transceiver receiving said insertion signal, to cause said room appliance to enter an energy-saving mode subsequent to said secondary unit transceiver receiving said removal signal, and to cause said room appliance to enter a powered mode substantially upon said secondary transceiver receiving said periodic status signal if said periodic status signal indicates said keycard switch is activated;
a gateway connected to a system controller, said gateway comprising a gateway transceiver adapted to communicate wirelessly with said secondary units, and said system controller being adapted to determine the mode of said secondary units and to cause one or more of said secondary units to change said mode.

2. The system of claim 1 wherein at least one said secondary unit comprises a thermostat and said room appliance comprises a heating and air conditioning unit wherein said secondary unit controller is further adapted to adjust the temperature setting of said thermostat.

3. The system of claim 1 wherein at least one said secondary unit comprises a male light socket portion configured to engage a light bulb socket and a female light socket portion configured to receive a light bulb and said secondary unit controller is configured to cause said secondary unit to electrically connect said male light socket portion to said female light socket portion substantially upon said secondary unit transceiver receiving said insertion signal and to electrically disconnect said female light socket portion from said male light socket portion subsequent to said secondary unit transceiver receiving said removal signal.

4. The system of claim 1 wherein at least one said secondary unit comprises a female wall socket portion configured to receive a standard male electrical plug and wherein said secondary unit controller is configured to connect said power source to said female wall socket portion substantially upon said secondary unit transceiver receiving said insertion signal and to disconnect said power source from said wall socket portion subsequent to said secondary unit transceiver receiving said removal signal.

5. The system of claim 4 wherein said power source comprises an electrical outlet and said means to connect to a power source comprises a male wall socket portion adapted to engage said electrical socket.

6. The system of claim 5 wherein said secondary unit further comprises a means to secure said secondary unit to said electrical outlet.

7. The system of claim 1 wherein said system controller is a general purpose computer and said system controller and said gateway are connected to a network.

8. The system of claim 7 wherein said network is a wired local area network.

9. The system of claim 7 wherein said network is a wireless local area network.

10. The system of claim 7 wherein said network is a wide area network.

11. The system of claim 1 wherein said secondary unit further comprises a manual command means and said secondary unit controller is further adapted such that, substantially upon activation of said manual command means said secondary unit enters said powered mode for a predetermined period of time after which said secondary unit enters said energy-saving mode.

12. The system of claim 11 wherein said manual command means comprises a manual command switch on said secondary unit.

13. The system of claim 11 wherein said manual command means comprises said system controller being further adapted to cause said gateway to transmit an enter-override-mode signal to said secondary unit.

14. The system of claim 1 wherein said system controller is further adapted to cause said gateway to transmit an enter-unoccupied-mode signal, said secondary unit controller is adapted to cause said room appliance to enter a power-saving mode substantially upon said secondary unit transceiver receiving said enter-unoccupied-mode signal.

15. The system of claim 14 wherein said secondary unit controller is further adapted to cause said room appliance to remain in said power-saving mode for a predetermined period of time.
